(19) United States
(12) Patent Application Publication
(10) Pub. No.: US 2009/0033836 A1
(43) Pub. Date: Feb. 5, 2009

(54) LIQUID CRYSTAL DISPLAY

(75) Inventor: Tsuyoshi Kamada, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/176,631

(22) Filed: Jul. 21, 2008

(30) Foreign Application Priority Data
Jul. 30, 2007 (JP) 2007-197952

(51) Int. Cl. G02F 1/1335

(52) U.S. Cl. 349/96

(57) ABSTRACT

A liquid crystal display capable of improving the transmittance of corners of pixel is provided. The liquid crystal display with a plurality of pixels arranged in a matrix includes a drive substrate with pixel electrodes formed correspondingly to the plurality of pixels, respectively, an opposite substrate arranged oppositely to the drive substrate, and polarizing plates provided on the drive substrate and the opposite substrate, respectively. An external form of the pixel electrodes is a trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates.

The present invention contains subject matter related to Japanese Patent Application JP 2007-197952 filed in the Japanese Patent Office on Jul. 30, 2007, the entire contents of which being incorporated here by reference.

### BACKGROUND OF THE INVENTION

1. Field of the Invention

The present invention relates to a liquid crystal display particularly suitable for VA (vertical alignment) mode.

2. Description of the Related Art

In order to improve the viewing angle characteristic in middle tone, a new technique called “multi-pixel” has recently been introduced in liquid crystal displays for VA mode used in liquid crystal display television sets and the like. As shown in FIG. 8, each pixel is divided into a plurality of sub-pixels A and B. With respect to the inputted gradation, the sub-pixels A firstly increase the luminance thereof and thereafter the sub-pixels B increase the luminance thereof. For attaining more excellent viewing angle characteristic, it is preferable to make the sub-pixels A small so that the ratio of the area of the sub-pixels A to the area of the sub-pixels B is approximately 1:2 rather than 1:1.

FIGS. 9A and 9B show the configuration of pixel electrodes and the configuration of a common electrode of these sub-pixels A and B, respectively. FIG. 9C shows the equivalent circuit thereof. There are some methods of applying a potential difference between the sub-pixels A and B. FIGS. 9A to 9C show, for example, the case where dedicated thin film transistors TFT1 and TFT2 are configured to be driven by disposing the thin film transistors TFT1 and TFT2 at the sub-pixels A and B, respectively, and disposing two source bus lines SL1 and SL2 on a single gate bus line GL.

The multi-pixel includes the TFT1 and TFT2, a liquid crystal element Clc1 constituting the sub-pixel A, a liquid crystal element Clc2 constituting the sub-pixel B, and capacity elements Cst1 and Cst2. The gates of the TFT1 and TFT2 are connected to the gate bus line GL. The source of the TFT1 is connected to the source bus line SL1, and the drain thereof is connected to one end of the liquid crystal element Clc1 and one end of the capacity element Cst1. The source of the TFT2 is connected to the source bus line SL2, and the drain thereof is connected to one end of the liquid crystal element Clc2 and one end of the capacity element Cst2. The other end of the capacity element Cst1 and the other end of the capacity element Cst2 are connected to a capacity element bus line CL.

A pixel electrode Px1 for the sub-pixel A is connected to the TFT1, and a pixel electrode Px2 for the sub-pixel B is connected to the TFT2. As shown in the equivalent circuit diagram of FIG. 9C, the pixel electrode Px1 for the sub-pixel A and the pixel electrode Px2 for the sub-pixel B are electrically independent, and a control circuit determines what voltage should be written in the pixel electrodes Px1 and Px2, respectively.

The pixel electrodes Px1 and Px2 have, as a configuration peculiar to the VA mode, a slit 112 for aligning liquid crystal molecules at an inclination of 45 degrees. A part of the slit 112 is also used as a slit for separating the pixel electrodes Px1 and Px2. On the other hand, a common electrode 121 arranged on the opposite substrate also needs a slit 122 for regulating the liquid crystal orientation. As liquid crystal orientation regulating means on the opposite substrate, in some cases, insulating projections (not shown) are formed on the common electrode 121. In FIG. 9A, the slit 122 of the common electrode 121 is indicated by the broken line.

FIGS. 10A and 10B and FIGS. 11A and 11B are for explaining the width of the slit 112. Cell thickness d of a liquid crystal display, that is, the distance between the TFT substrate 110 and the opposite substrate 120 is usually approximately 4 μm. When the width of the slit 112 is sufficiently large with respect to the cell thickness d, the equipotential surface of the slit 112 is inserted deeply into the glass of the TFT substrate 110, as shown in FIG. 10A. In the slit 112, the vertical electric field is weakened. Therefore, the vertical alignment of the liquid crystal molecules 131 of the slit 112 is retained, and a sufficiently oblique electric field is generated on the pixel electrodes Px1 and Px2 in the vicinity of the slit 112, thereby stabilizing the liquid crystal orientation, as shown in FIG. 10B.

In the slit 112, the liquid crystal molecules 131 do not lean and hence do not contribute to transmittance. Therefore, increasing the width of the slit 112 decreases the substantial aperture ratio and lowers transmittance. On the other hand, decreasing the width of the slit 112 increases the aperture ratio; however, the electric field near the slit 112 gradually lose its inclined position as shown in FIG. 11A, and the orientation stability of the liquid crystal molecules 131 is deteriorated, as shown in FIG. 11B. When the azimuth of the liquid crystal molecules 131 deviates from 45 degrees, the effect of the liquid crystal molecules 131 against polarized light is changed and the transmittance per unit area is decreased. As a result, the total transmittance is lowered in spite of the increased aperture ratio.

That is, as shown in FIG. 12, there is an optimum value in the width of the slit 112 with respect to the transmittance, and it is usually designed so that the width of the slit 112 is approximately 10 μm with respect to the cell thickness d of 4 μm.

FIG. 13 shows the orientation of the liquid crystal molecules 131 on the slit 112 when reverse polarity voltages are applied to the two pixel electrodes Px1 and Px2. In this case, the equipotential surface is greatly different from that shown in FIG. 10A and FIG. 11A. That is, the equipotential surface is inserted vertically to the slit 112 between the pixel electrodes Px1 and Px2. A region having the same potential as the common electrode 121 is surely formed on the slit 112. In the same potential region, the liquid crystal molecules 131 do not lean and become extremely vertically stable. Owing to the strong oblique electric field thereof, the orientation of the liquid crystal molecules 131 is extremely stable. This effect is enhanced as the width of the slit 112 is decreased.

FIGS. 14A and 14B show the case of narrowing a slit 112A between the pixel electrodes Px1 and Px2, provided that reverse polarity voltages are applied to the above two pixel electrodes Px1 and Px2 in the multi-pixel shown in FIGS. 9A to 9C, taking the abovementioned effect into consideration. FIG. 15 shows the case where the pixels shown in FIGS. 14A and 14B are arranged in a 2×2 matrix. It may be regarded that this is repeated in an actual display.

FIG. 16 shows the transmittance when the distance between the slits 112A is reduced as shown in FIGS. 14A and 14B and FIG. 15. The following will be seen from FIG. 16. That is, in the application of the same polarity voltage to the two pixel electrodes Px1 and Px2 (i.e. the same polarity driving), when the distance between the slits 112A is 10 μm or less, the transmittance is lowered due to the deteriorated liquid crystal orientation. On the other hand, in the application of the opposite polarity voltages to these two pixel electrodes Px1 and Px2 (i.e. the reverse polarity driving), the transmittance is able to be improved by narrowing the slits 112A (for example, refer to Japanese Unexamined Patent Application Publication No. 2005-316211).

### SUMMARY OF THE INVENTION

However, the above narrow slitting is applicable only to the slit 112A between the two sub-pixels A and B. In the case shown in FIGS. 14A and 14B, this is applicable to four slits among six slits 112 on the TFT substrate 110 side. The design of the remaining two slits 112B and the design of the slits 122 of the common electrode 121 on the opposite substrate 120 remain the same as before.

Even after the narrow slitting as shown in FIGS. 14A and 14B is applied to the pixels, there remain regions where the orientation of liquid crystal molecules is poor and the light utilization efficiency is low. FIG. 17A shows the same pixel as shown in FIGS. 14A and 14B. FIG. 17B shows the result of simulation of the transmittance of the pixel shown in FIG. 17A, specifically showing in enlarged dimension the part surrounded by the dotted line at the lower left corner of the pixel shown in FIG. 17A. Although the upper left corner is not shown, the result thereof seems almost the same in spite of the azimuth difference.

As can be seen from FIG. 17B, especially the corners of pixel have extremely poor transmittance. This is attributed to mismatch between the basic shape of pixels and the orientation direction of liquid crystal molecules. The liquid crystal molecules inclined in 45 degree directions can exhibit the maximum transmittance from the relationship with the optical axis of a polarizing plate. Hence, the slit 112 is arranged at an angle of 45 degrees. However, the basic shape of pixels is a rectangle, and the azimuth of liquid crystal molecules will deviate at the corners of pixel due to the influence of the longitudinally and laterally cut patterns of the pixel electrodes Px1 and Px2. This is hereinafter referred to as “φ (azimuth) blur.” Especially at the corners of pixel, the concentration of the φ blur occurs at the right and left ends and the upper and lower ends, and the deterioration of transmittance becomes remarkable.

It is desirable to provide a liquid crystal display capable of improving the transmittance of corners of pixel.

According to an embodiment of the present invention, there is provided a first liquid crystal display with a plurality of pixels arranged in a matrix, including a drive substrate with pixel electrodes formed correspondingly to the plurality of pixels, respectively, an opposite substrate arranged oppositely to the drive substrate, and polarizing plates provided on the drive substrate and the opposite substrate, respectively. The external form of the pixel electrodes is a trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates.

According to an embodiment of the present invention, there is provided a second liquid crystal display with a plurality of pixels arranged in a matrix, including a drive substrate with pixel electrodes formed correspondingly to the plurality of pixels, respectively, an opposite substrate arranged oppositely to the drive substrate, and polarizing plates provided on the drive substrate and the opposite substrate, respectively. The pixel electrodes have an even number of unit pixel electrodes, and the external form of the unit pixel electrodes is a trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates.

According to an embodiment of the present invention, there is provided a third liquid crystal display with a plurality of pixels arranged in a matrix, including a drive substrate with pixel electrodes formed correspondingly to the plurality of pixels, respectively, an opposite substrate arranged oppositely to the drive substrate, and polarizing plates provided on the drive substrate and the opposite substrate, respectively. The external form of the pixel electrodes is a shape having the upper and lower sides inclined at an angle of any one of 45 degrees, 135 degrees, 225 degrees and 315 degrees with respect to the optical axes of the polarizing plates.

In the first liquid crystal display of the embodiment of the present invention, the external form of the pixel electrodes is the trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates. This enables the φ blur at the corners of pixel to be reduced to improve transmittance.

In the second liquid crystal display of the embodiment of the present invention, the pixel electrodes have an even number of unit pixel electrodes, and the external form of the unit pixel electrodes is the trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates. This enables the φ blur at the corners of pixel to be reduced to improve transmittance.

In the third liquid crystal display of the embodiment of the present invention, the external form of the pixel electrodes is the shape having the upper and lower sides inclined at an angle of any one of 45 degrees, 135 degrees, 225 degrees and 315 degrees with respect to the optical axes of the polarizing plates. This enables the φ blur at the corners of pixel to be reduced to improve transmittance.

In the first liquid crystal display of the embodiment of the present invention, the external form of the pixel electrodes is the trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates. In the second liquid crystal display of the embodiment of the present invention, the pixel electrodes have an even number of unit pixel electrodes, and the external form of the unit pixel electrodes is the trapezoid having the right and left sides parallel to the optical axes of the polarizing plates, and the upper and lower sides inclined at an angle of any one of 45 degrees, 135 degrees, 225 degrees and 315 degrees. In the third liquid crystal display of the embodiment of the present invention, the external form of the pixel electrodes is the shape having the upper and lower sides inclined at an angle of any one of 45 degrees, 135 degrees, 225 degrees and 315 degrees with respect to the optical axes of the polarizing plates. These liquid crystal displays are capable of reducing the φ blur at the corners of pixel, thus improving transmittance.

Other and further objects, features and advantages of the invention will appear more fully from the following description.

### BRIEF DESCRIPTION OF THE DRAWINGS

FIG. 1 is a diagram showing the overall configuration of a liquid crystal display provided with a liquid crystal display panel according to a first embodiment of the invention;

FIG. 2 is an equivalent circuit diagram of pixels of the liquid crystal display panel shown in FIG. 1;

FIG. 3 is a sectional view showing the structure of a part of the liquid crystal display panel shown in FIG. 1;

FIG. 4 is a plan view of pixel electrodes shown in FIG. 3;

FIG. 5 is a plan view showing separately the pixel electrodes shown in FIG. 4;

FIG. 6 is a plan view of pixel electrodes according to a second embodiment of the invention;

FIG. 7 is a plan view showing separately the pixel electrodes shown in FIG. 6;

FIG. 8 is a diagram showing an example of gradation display by the multi-pixels of the related art;

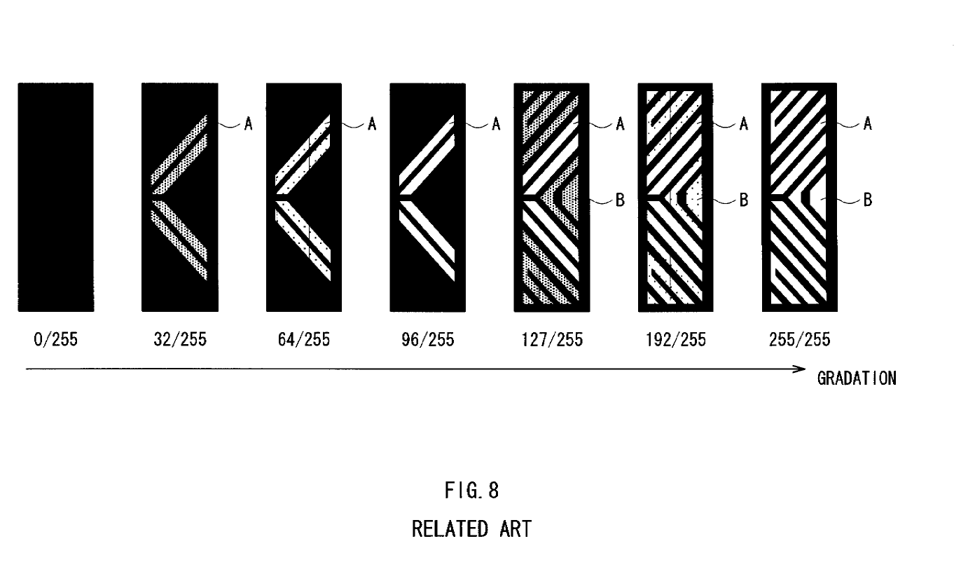

FIGS. 9A, 9B and 9C are diagrams showing the configuration of pixel electrodes of each sub-pixels shown in FIG. 8, the configuration of a common electrode thereof, and the equivalent circuit diagram thereof, respectively;

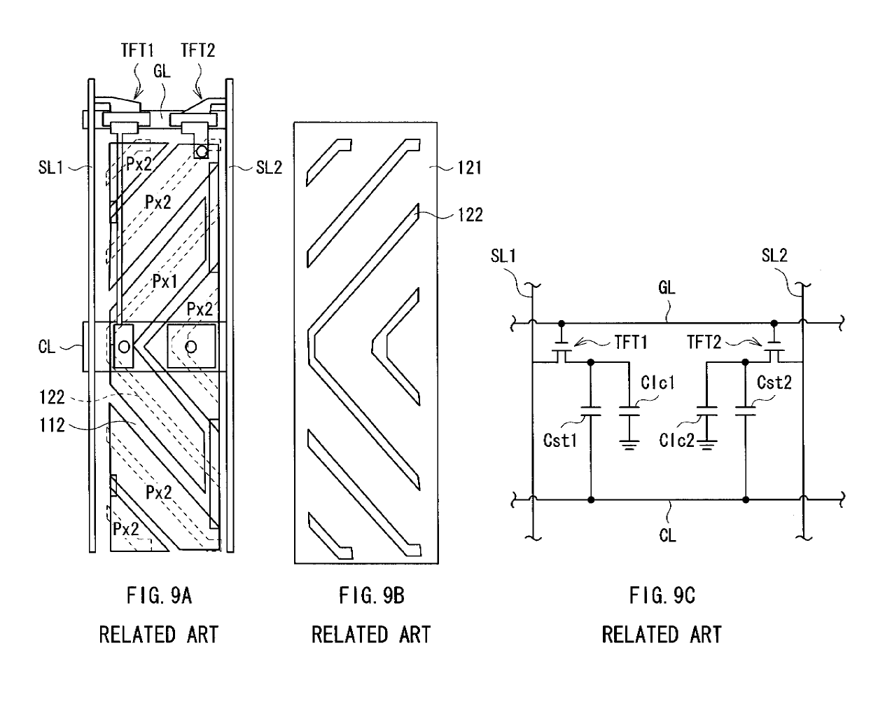

FIGS. 10A and 10B are diagrams for explaining the slit width shown in FIGS. 9A to 9C;

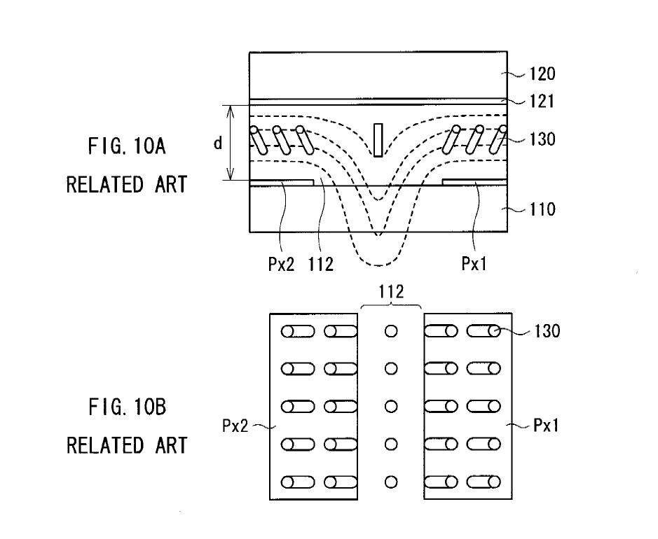

FIGS. 11A and 11B are diagrams for explaining the slit width shown in FIGS. 9A to 9C;

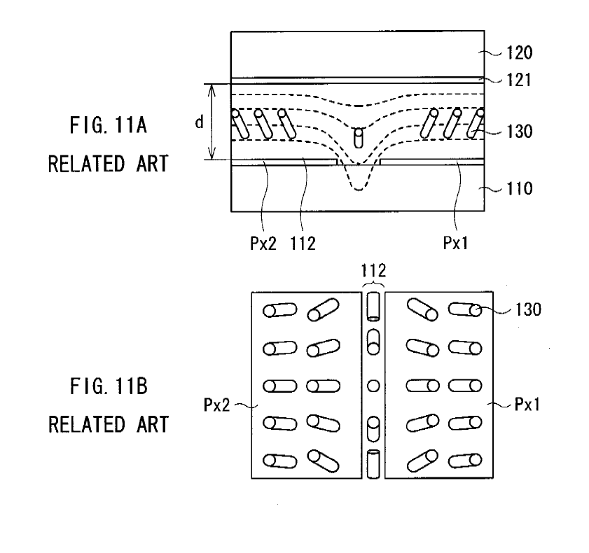

FIG. 12 is a diagram showing the relationship between the slit width and transmittance;

FIG. 13 is a diagram for explaining the orientation of liquid crystal molecules in the slit when reverse polarity voltages are applied to the two pixel electrodes shown in FIGS. 9A to 9C;

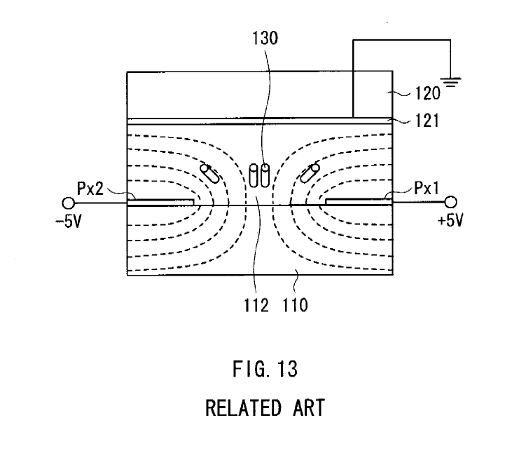

FIGS. 14A and 14B are plan views showing the pixel configuration of reverse polarity driving;

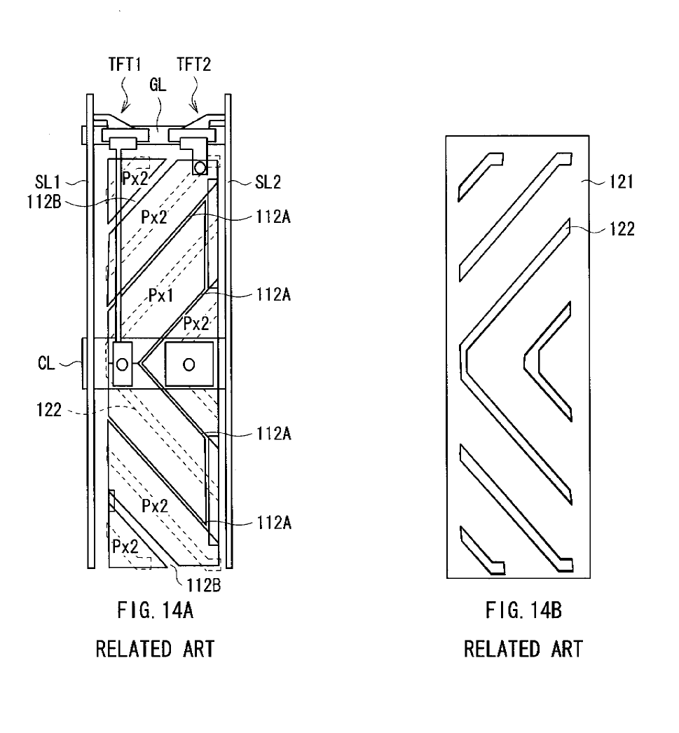

FIG. 15 is a plan view showing the case of arranging in a 2×2 matrix the pixels shown in FIGS. 14A and 14B;

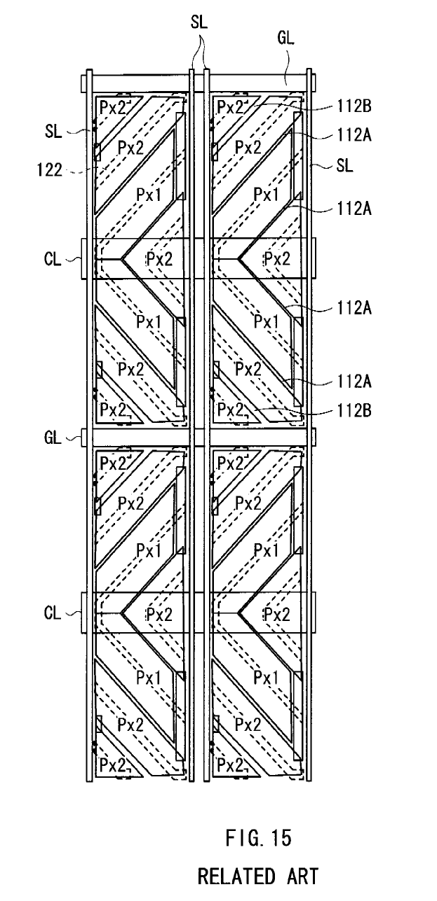

FIG. 16 is a diagram showing the transmittance when the slit width is narrowed; and

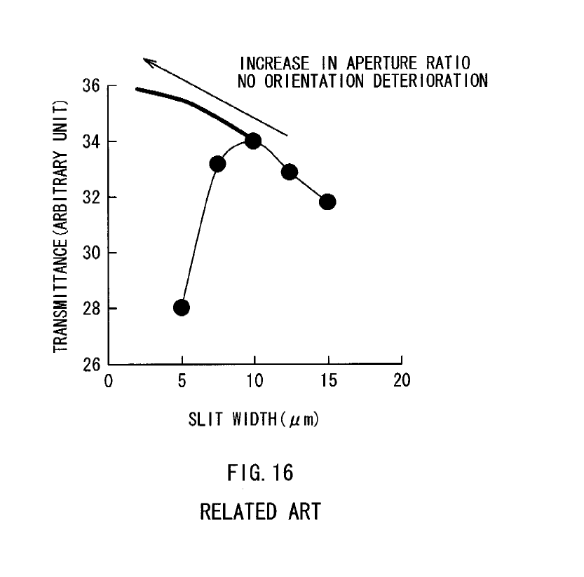

FIGS. 17A and 17B are diagrams showing the simulation result of the transmittance of pixels of the related art.

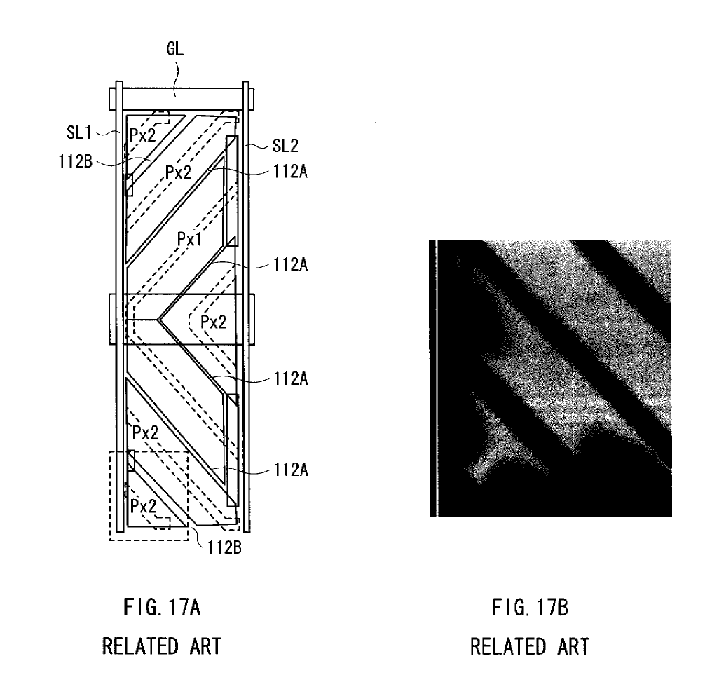

### DESCRIPTION OF THE PREFERRED EMBODIMENTS

Embodiments of the present invention will be described below in detail with reference to the accompanying drawings.

### First Embodiment

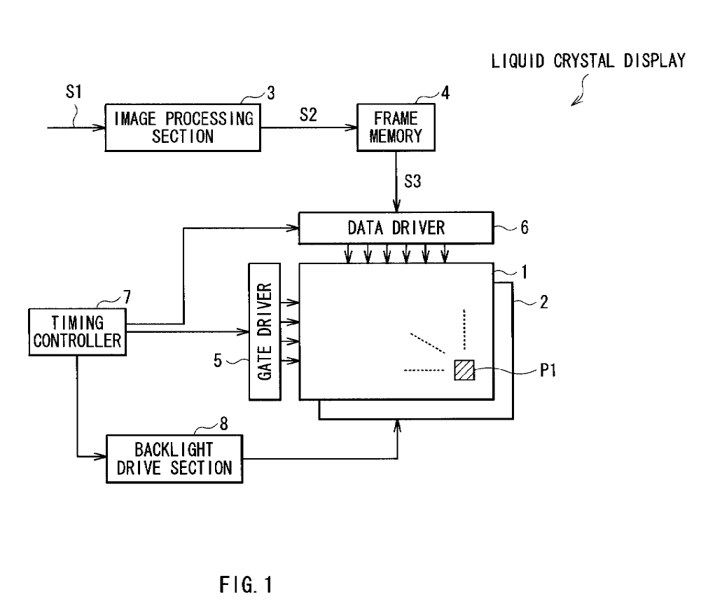

FIG. 1 shows the configuration of a liquid crystal display according to a first embodiment of the invention. The liquid crystal display is a liquid crystal display for VA mode used in a liquid crystal display television set or the like, and provided with, for example, a liquid crystal display panel 1, a backlight section 2, an image processing section 3, a frame memory 4, a gate driver 5, a data driver 6, a timing controller 7 and a backlight driver 8.

The liquid crystal display panel 1 performs image display based on a video signal Di transmitted from the data driver 6 by a drive signal supplied from the gate driver 5. The display panel 1 is an active matrix type liquid crystal display panel configured so that a plurality of pixels P1 arranged in a matrix are driven per pixel P1. The specific configuration of these pixels P1 will be described later.

The backlight section 2 is a light source for applying light to the liquid crystal display panel 1, and configured by including, for example, a CCFL (cold cathode fluorescent lamp) and an LED (light emitting diode).

The image processing section 3 generates a video signal S2 as a RGB signal, by applying a predetermined image processing to a video signal S1 from the outside.

The frame memory 4 stores the video signal S2 supplied from the image processing section 3 in frame for each pixel P.

The timing controller 7 controls the drive timings of the gate driver 5, the data driver 6 and the backlight driver 8. The backlight driver 8 controls the lighting operation of the backlight section 2 in accordance with the timing control of the timing controller 7.

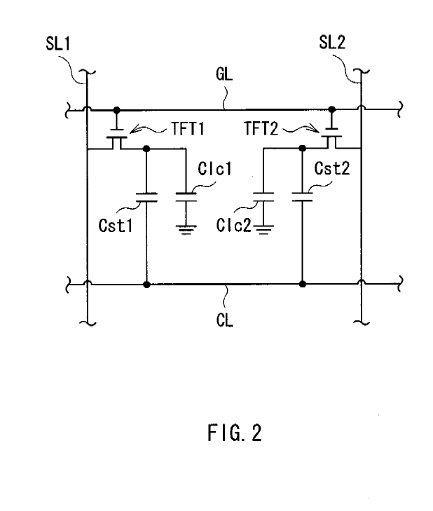

The specific configuration of the each pixel P1 of the liquid crystal display panel 1 will be described below with reference to FIGS. 2 to 4. The each pixel P1 has multi-pixel structure including two sub-pixels, and is configured to display one of the basic colors of red (R), green (G) and blue (B).

FIG. 2 shows the equivalent circuit of the pixels P1. The pixel P1 has TFT1 and TFT2, a liquid crystal element Clc1 constituting a sub-pixel (hereinafter referred to as a “sub-pixel A”), a liquid crystal element Clc2 constituting the other sub-pixel (hereinafter referred to as a “sub-pixel B”), and capacity elements Cst1 and Cst2.

The TFT1 and TFT2 have a function as a switching element for supplying a video signal S3 to the sub-pixels A and B. For example, these TFT1 and TFT2 are configured by an MOS-FET (metal oxide semiconductor-field effect transistor), and have three electrodes, a gate, a source and a drain. The gates of the TFT1 and TFT2 are connected to a gate bus line GL extending laterally. Two source bus lines SL1 and SL2 extending vertically are crossed rectangularly to the gate bus line GL. The source of the TFT1 is connected to the source bus line SL1, and the drain thereof is connected to one end of the liquid crystal element Clc1 and one end of the capacity element Cst1. The source of the TFT2 is connected to the source bus line SL2, and the drain thereof is connected to one end of the liquid crystal element Clc2 and one end of the capacity element Cst2.

The liquid crystal elements Clc1 and Clc2 have a function as display elements performing the display operation in accordance with a signal voltage supplied through the TFT1 and TFT2, respectively. The other end of the liquid crystal element Clc1 and the other end of the liquid crystal element Clc2 are grounded.

The capacity elements Cst1 and Cst2 are for generating a potential difference between two ends, specifically configured by including a dielectric body causing electric charge to be accumulated. The other end of the capacity element Cst1 and the other end of the capacity element Cst2 are connected to a capacity element bus line CL extending in parallel, namely laterally to the gate bus line GL.

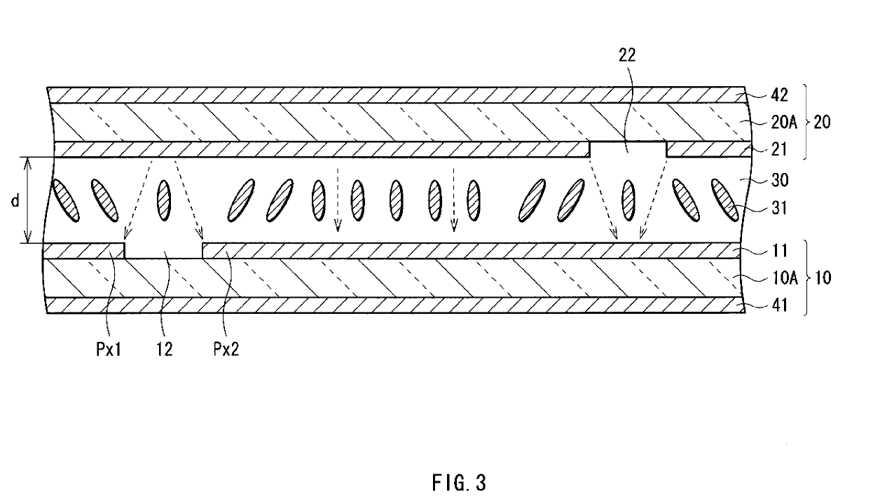

FIG. 3 shows the cross-sectional configuration of the liquid crystal display panel 1. The liquid crystal display panel 1 has a liquid crystal layer 30 between a TFT substrate (a drive substrate) 10 and an opposite substrate 20. Polarizing plates 41 and 42 are arranged so as to rectangularly cross their optical axes (not shown) on the TFT substrate 10 and the opposite substrate 20, respectively.

The TFT substrate 10 has, on a glass substrate 10A, pixel electrodes 11 formed correspondingly to the plurality of pixels P1, respectively. The glass substrate 10A is provided with the TFT1 and TFT2, the capacity elements Clc1 and Clc2 and the like as shown in FIG. 2 (all these are not shown in FIG. 3). The pixel electrodes 11 are provided with a slit 21 for controlling the liquid crystal orientation.

The opposite substrate 20 is attained by forming a common electrode 21 on a glass substrate 20A. The glass substrate 20A is provided with a color filter, a black matrix and the like (All these are not shown in FIG. 3). The common electrode 21 has a slit 21 for controlling the liquid crystal orientation at such a position as not overlapped with the slit 12 of the pixel electrode 11.

The liquid crystal layer 30 is a liquid crystal layer of VA mode and composed of liquid crystal molecules 31.

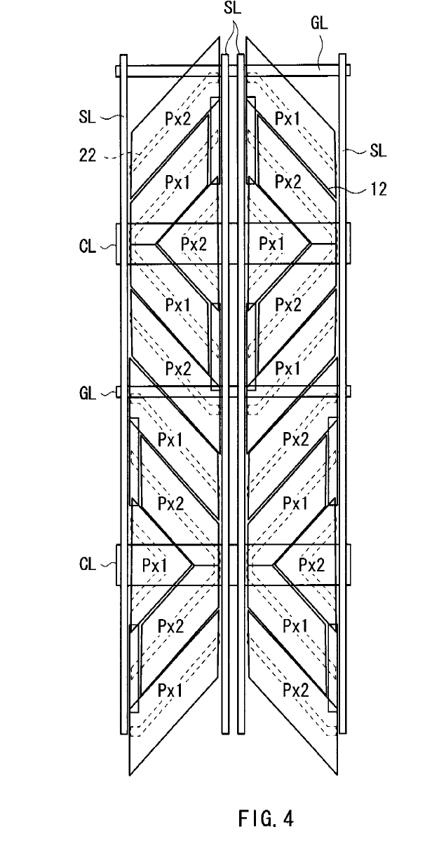

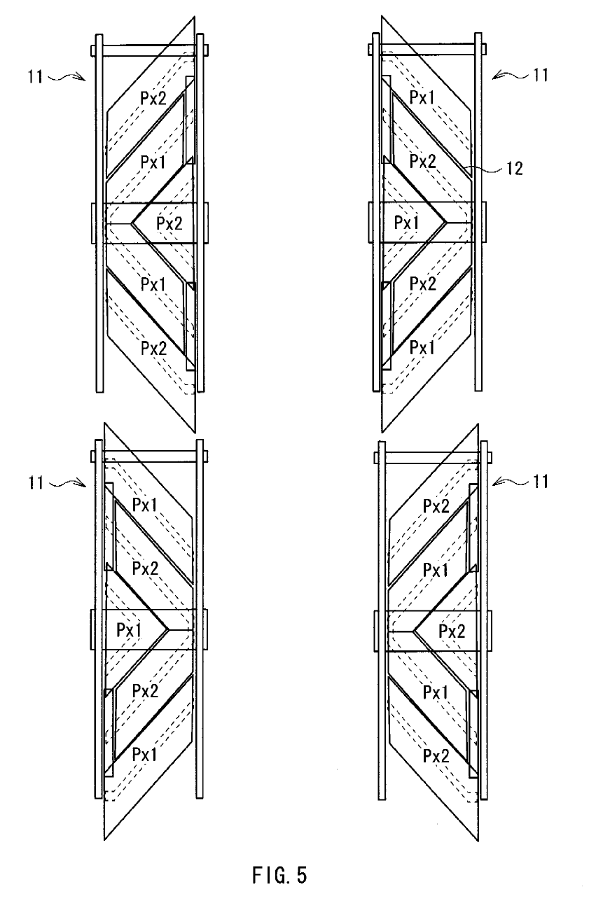

FIG. 4 shows the pixel electrodes 11 of four pixels P1 arranged side by side. FIG. 5 shows separately the four pixel electrodes 11 shown in FIG. 4. The external form of the pixel electrodes 11 is a trapezoid vertically arranged at an angle of 90 degrees. The right and left sides of the pixel electrode 11 are the parallel sides of the trapezoid and are parallel to the optical axes of the polarizing plates 41 and 42. The upper and lower sides of the pixel electrode 11 are the inclined sides of the trapezoid and are inclined at an angle of any one of 45 degrees, 135 degrees, 225 degrees and 315 degrees with respect to the optical axes of the polarizing plates 41 and 42. This enables the liquid crystal display to improve the transmittance of the corners of pixels P1.

The pixel electrode 11 and the laterally adjacent pixel electrodes 11 are arranged in line symmetry with respect to a vertical axis. The pixel electrode 11 and the vertically adjacent pixel electrodes 11 are arranged in point symmetry. The upper and lower sides of the pixel electrodes 11 and the upper and lower sides of pixel electrodes 11 vertically adjacent to the former pixel electrodes 11 are parallel to each other. This enables to eliminate dead space.

The pixel electrode 11 has sub-pixel electrodes Px1 and Px2. The sub-pixel electrode Px1 constitutes the sub-pixel A and is connected to the TFT1 (not shown in FIG. 4 and see FIG. 2). The sub-pixel electrode Px2 constitutes the sub-pixel B and is connected to the TFT2 (not shown in FIG. 4 and see FIG. 2). As shown in the equivalent circuit diagram of FIG. 2, the sub-pixel electrode Px1 and the sub-pixel electrode Px2 are electrically independent of each other, and these sub-pixel electrodes Px1 and Px2 are subjected to reverse polarity voltage application within the same frame. This contributes to a reduction in the width of the slit 12 within the pixel P1, thereby improving transmittance.

Preferably, the pixel electrode 11 and the vertically or laterally adjacent pixel electrodes 11 have the reverse polarity relationship among a plurality of the sub-pixel electrodes Px1 and Px2. This enables to narrow the slit 12 between the adjacent pixel electrodes 11, thereby further improving transmittance.

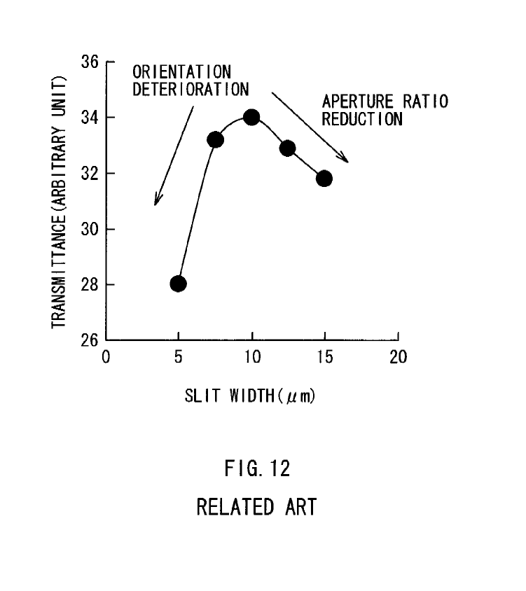

That is, in the rectangular pixel electrodes of the related art, it has been difficult to design so that the sub-pixel electrodes Px1 and Px2 of reverse polarity driving are efficiently arranged adjacently to each other. In FIG. 12, the two slits 112A at the corners are disposed between the pixel electrodes Px2 of the same polarity driving, requiring a large width of 10 μm. Consequently, the corners of pixel have failed to enjoy the advantage of the improved transmittance owing to the narrow slit.

The above liquid crystal display may be manufactured by a normal manufacturing method, except that the pixel electrodes 11 are formed into the external form as shown in FIG. 4.

In the liquid crystal display panel 1, as shown in FIG. 1, a video signal S1 supplied from the outside is subjected to image processing by the image processing section 3, thereby generating a video signal S2 for each pixel P1. The video signal S2 is stored in the frame memory 4, and supplied as a video signal S3 to the data driver 6. Based on the video signal S3 thus supplied, the line sequential display driving operation for each of the individual pixels P1 is performed by using the drive voltage into the pixels P1 to be outputted from the gate driver 5 and the data driver 6. Specifically, in response to a selection signal supplied from the gate driver 5 through the gate bus line GL, the ON/OFF of the TFT1 and TFT2 are switched to perform selective electrical connection between the source bus line SL and the pixel P1. Thus, the illumination light from the backlight section 2 is modulated and outputted as a display light by the liquid crystal display panel 1.

In this case, the external form of the pixel electrodes 11 is the trapezoid having the right and left sides parallel to the optical axes of the polarizing plates 41 and 42, and the upper and lower sides inclined at an angle of any one of 45 degrees, 135 degrees, 225 degrees and 315 degrees with respect to the optical axes of the polarizing plates 41 and 42. Hence, the mismatch between the orientation direction of the liquid crystal molecules 31 and the external form of the pixel electrodes 11 is resolved. This enables the φ blur at the corners of pixel P1 to be reduced to improve transmittance.

Thus, in the first embodiment, the external form of the pixel electrode is formed into the trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates. This enables the φ blur at the corners of pixel to be reduced to improve transmittance.

### Second Embodiment

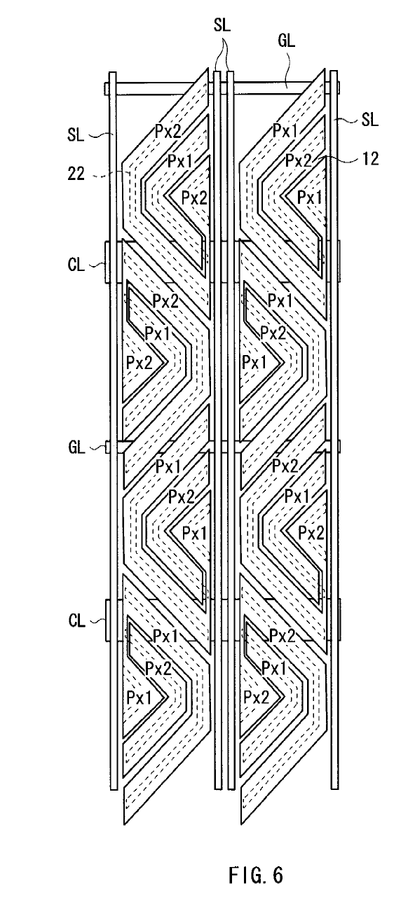

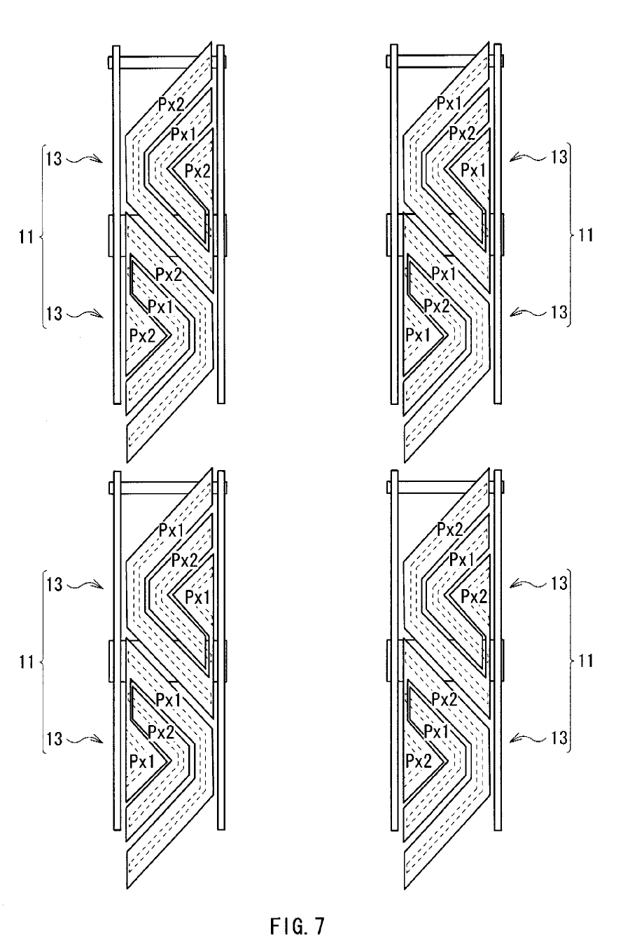

FIG. 6 shows pixel electrodes 11 of four pixels P1 arranged side by side in a liquid crystal display panel 1 according to a second embodiment of the invention. FIG. 7 shows separately the four pixel electrodes 11 shown in FIG. 6. The configuration of the second embodiment is identical to that described in the first embodiment, except for the pixel P1 of the liquid crystal display panel 1. Therefore, the same references are retained for similar parts.

The pixel electrode 11 has an even number of (for example, two) unit pixel electrodes 13. The external form of the unit pixel electrodes 13 is a trapezoid vertically arranged at an angle of 90 degrees. The right and left sides of the unit pixel electrodes 13 are the parallel sides of the trapezoid and are parallel to the optical axes of polarizing plates 41 and 42, and the upper and lower sides of the unit pixel electrodes 13 are the inclined sides of the trapezoid and inclined at an angle of any one of 45 degrees, 135 degrees, 225 degrees and 315 degrees with respect to the optical axes of the polarizing plates 41 and 42. This enables the liquid crystal display to improve the transmittance of the corners of pixel P1.

These two unit pixel electrodes 13 are vertically adjacent to each other and arranged in point symmetry within the pixel P1. That is, the upper and lower sides of the unit pixel electrodes 13 and the upper and lower sides of unit pixel electrodes 13 vertically adjacent to the former unit pixel electrode 13 are parallel to each other. This enables to eliminate dead space.

Alternatively, the pixel electrode 11 and the laterally adjacent pixel electrodes 11 may or may not be arranged in line symmetry with respect to a vertical axis.

Each of these two unit pixel electrodes 13 has subunit pixel electrodes Px1 and Px2. The subunit pixel electrode Px1 constitutes a sub-pixel A and is connected to the TFT1 (not shown in FIG. 6 and see FIG. 2). The subunit pixel electrode Px2 constitutes a sub-pixel B and is connected to the TFT2 (not shown in FIG. 6 and see FIG. 2). The TFT1 is common to the subunit pixel electrodes Px1 of these two unit pixel electrodes 13, and the TFT2 is common to the subunit pixel electrodes Px2 of these two unit pixel electrodes 13. As described in the equivalent circuit diagram of FIG. 2, the subunit pixel electrode Px1 and the subunit pixel electrode Px2 are electrically independent of each other, and these subunit pixel electrodes Px1 and Px2 are subjected to reverse polarity voltage application within the same frame. This contributes to a reduction in the width of a slit 12 within the pixel P1, thereby improving transmittance.

Preferably, the pixel electrode 11 and the vertically or laterally adjacent pixel electrodes 11 have the reverse polarity relationship among a plurality of the subunit pixel electrodes Px1 and Px2. This enables to narrow the slit 12 between the adjacent pixel electrodes 11, further improving transmittance.

The above liquid crystal display may be manufactured by a normal manufacturing method, except that the unit pixel electrodes 13 are formed into the external form as shown in FIG. 6.

In the liquid crystal display panel 1, as shown in FIG. 1, the line sequential display driving operation for each of the pixels P1 is performed similarly to the first embodiment, so that the illumination light from the backlight section 2 is modulated by the liquid crystal display panel 1 and outputted as a display light.

In this case, the pixel electrodes 11 have two unit pixel electrodes 13, and the external form of the unit pixel electrodes 13 is the trapezoid having the right and left sides parallel to the optical axes of the polarizing plates 41 and 42, and the upper and lower sides inclined at an angle of any one of 45 degrees, 135 degrees, 225 degrees and 315 degrees with respect to the optical axes of the polarizing plates 41 and 42. Hence, the mismatch between the orientation direction of the liquid crystal molecules 31 and the external form of the pixel electrodes 11 is resolved. This enables the φ blur at the corners of pixel P1 to be reduced to improve transmittance.

Further in the second embodiment, the pixels P1 have two different types of shapes, that is, the right-bent shape and the left-bent shape. The viewing angle characteristic is affected by the shape of the pixels P1. Therefore, strictly speaking, there is a slight difference in viewing angle between these two types of pixels. Since these two types of the pixels P1 are finely arranged in a zigzag array, no odd feeling is generated from normal images. However, when the original image is a zigzag pattern, slight odd feeling may be generated. On the contrary, in the second embodiment, the pixel electrode 11 includes the two unit pixel electrodes 13. Therefore, two types of viewing angle characteristics are averaged within a single pixel P1, eliminating the generation of odd feeling due to the difference of viewing angle characteristic, irrespective of the pattern type.

Thus, in the second embodiment, the pixel electrode 11 has two unit pixel electrodes 13, and the external form of these pixel electrodes 13 is the trapezoid having the right and left sides parallel to the optical axes of the polarizing plates 41 and 42, and the upper and lower sides inclined at an angle of any one of 45 degrees, 135 degrees, 225 degrees and 315 degrees with respect to the optical axes of the polarizing plates 41 and 42. This enables the φ blur at the corners of pixel P1 to be reduced to improve transmittance.

Although the invention has been described above by way of the embodiments, the invention is not limited to these and is susceptible to various modifications. For example, the first and second embodiments are directed to the case where the external form of the pixel electrodes 11 or the unit pixel electrodes 13 is the trapezoid. The invention is not limited thereto and also applicable to a parallelogram, for example, in which the upper and lower sides are inclined at an angle of any one of 45 degrees, 135 degrees, 225 degrees and 315 degrees with respect to the optical axes of the polarizing plates.

Although the forgoing embodiments are directed to the case where each pixel is divided into the two sub-pixels, the invention is also applicable to the case where individual pixels are divided into more than two sub-pixels.

The shape of the sub-pixels is not limited to that in the foregoing embodiments, and the sub-pixels may have other shape such as square or rectangle. That is, it may be configured to substantially divide the plane area of pixels.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display with a plurality of pixels arranged in a matrix, comprising:
a drive substrate with pixel electrodes formed correspondingly to the plurality of pixels, respectively;
an opposite substrate arranged oppositely to the drive substrate; and
polarizing plates provided on the drive substrate and the opposite substrate, respectively, wherein
an external form of the pixel electrodes is a trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates.

2. The liquid crystal display according to claim 1, wherein the pixel electrodes have a plurality of sub-pixel electrodes, and each of the plurality of sub-pixel electrodes is connected to a nonlinear element and voltages applied to at least two of the plurality of sub-pixel electrodes are reverse in polarity within the same frame.

3. The liquid crystal display according to claim 2, wherein the pixel electrodes have a reverse polarity relationship between the plurality of sub-pixel electrodes, relative to vertically or laterally adjacent pixel electrodes.

4. The liquid crystal display according to claim 1, wherein the pixel electrodes and laterally adjacent pixel electrodes are line symmetrical with respect to a vertical axis.

5. The liquid crystal display according to claim 1, wherein the pixel electrodes and vertically adjacent pixel electrodes are arranged in point symmetry, and the upper and lower sides of the former pixel electrodes and the upper and lower sides of the latter pixel electrodes are parallel to each other.

6. A liquid crystal display with a plurality of pixels arranged in a matrix, comprising:
a drive substrate with pixel electrodes formed correspondingly to the plurality of pixels, respectively;
an opposite substrate arranged oppositely to the drive substrate; and
polarizing plates provided on the drive substrate and the opposite substrate, respectively, wherein
the pixel electrodes have an even number of unit pixel electrodes, and
the external form of the unit pixel electrodes is a trapezoid having the right and left sides parallel to the optical axes of the polarizing plates, and the upper and lower sides inclined at an angle of any one of 45 degrees, 135 degrees, 225 degrees and 315 degrees with respect to the optical axes of the polarizing plates.

7. The liquid crystal display according to claim 6, wherein the unit pixel electrodes have a plurality of subunit pixel electrodes, and each of the plurality of subunit pixel electrodes is connected to a nonlinear element and voltages applied to at least two of the plurality of sub-pixel electrodes are reverse in polarity within the same frame.

8. The liquid crystal display according to claim 7, wherein the pixel electrodes have a reverse polarity relationship between the plurality of subunit pixel electrodes, relative to vertically or laterally adjacent pixel electrodes.

9. The liquid crystal display according to claim 6, wherein the even number of unit pixel electrodes are vertically adjacent to each other and arranged in point symmetry.

10. The liquid crystal display according to claim 6, wherein the pixel electrodes and laterally adjacent pixel electrodes are line symmetrical with respect to a vertical axis.

11. The liquid crystal display according to claim 6, wherein the upper and lower sides of the unit pixel electrodes and the upper and lower sides of unit pixel electrodes vertically adjacent to the former pixel electrodes are parallel to each other.

12. A liquid crystal display with a plurality of pixels arranged in a matrix, comprising:
a drive substrate with pixel electrodes formed correspondingly to the plurality of pixels, respectively;
an opposite substrate arranged oppositely to the drive substrate; and
polarizing plates provided on the drive substrate and the opposite substrate, respectively, wherein
the external form of the pixel electrodes is a shape having the upper and lower sides inclined at an angle of any one of 45 degrees, 135 degrees, 225 degrees and 315 degrees with respect to the optical axes of the polarizing plates.

13. The liquid crystal display according to claim 12, wherein the upper and lower sides of the pixel electrodes and the upper and lower sides of pixel electrodes vertically adjacent to the former pixel electrodes are parallel to each other.
